(19) United States
(12) Patent Application Publication
(10) Pub. No.: US 2011/0259672 A1
(43) Pub. Date: Oct. 27, 2011

(54) POINT-OF-SALE TERMINAL

(75) Inventor: HENG-CHEN KUO, Tu-Cheng (TW)

(73) Assignee: HON HAI PRECISION INDUSTRY CO., LTD., Tu-Cheng (TW)

(21) Appl. No.: 12/820,059

(22) Filed: Jun. 21, 2010

(30) Foreign Application Priority Data
Apr. 27, 2010 (TW) 99113188

(51) Int. Cl. G06Q 30/00

(52) U.S. Cl. 186/59

(57) ABSTRACT

A POS terminal comprises a controller, a main display, a sub-display, and a multimedia display. The controller comprises a casing including a top plate. The main display is disposed on the top plate. The sub-display is disposed on the top plate, and the display panel of the sub-display facing substantially back away from the display panel of the main display.

The main board comprises a central processing unit (CPU), a south bridge chip (SBC) connected to the CPU, and a north bridge chip (NBC) connected to the CPU. The main display is connected to the NBC. The sub-display is connected to the SBC. The multimedia display is connected with the NBC.

### BACKGROUND

1. Technical Field

The present disclosure relates to a point-of-sale (POS) terminal that may be used in department stores, supermarkets, convenience stores, and the like.

2. Description of Related Art

Conventional POS terminals typically include two displays oppositely disposed for displaying titles and prices of purchased commodities for consumers and salesclerks simultaneously. However, conventional POS terminals are normally not able to show any additional information to consumers.

Therefore, it is desirable to provide a point-of-sale terminal which can overcome the above-mentioned limitations.

### BRIEF DESCRIPTION OF THE DRAWINGS

Many aspects of the present point-of-sale terminal should be better understood with reference to the following drawings. The components in the drawings are not necessarily drawn to scale, the emphasis instead being placed upon clearly illustrating the principles of the present point-of-sale terminal. Moreover, in the drawings, like reference numerals designate corresponding parts throughout the several views.

FIG. 1 is an isometric view of a point-of-sale terminal, according to a first embodiment.

FIG. 2 is a functional block diagram of the point-of-sale terminal of FIG. 1.

FIG. 3 is a functional block diagram of a point-of-sale terminal, according to a second embodiment.

### DETAILED DESCRIPTION

Embodiments of the present point-of-sale terminal will now be described in detail with reference to the drawings.

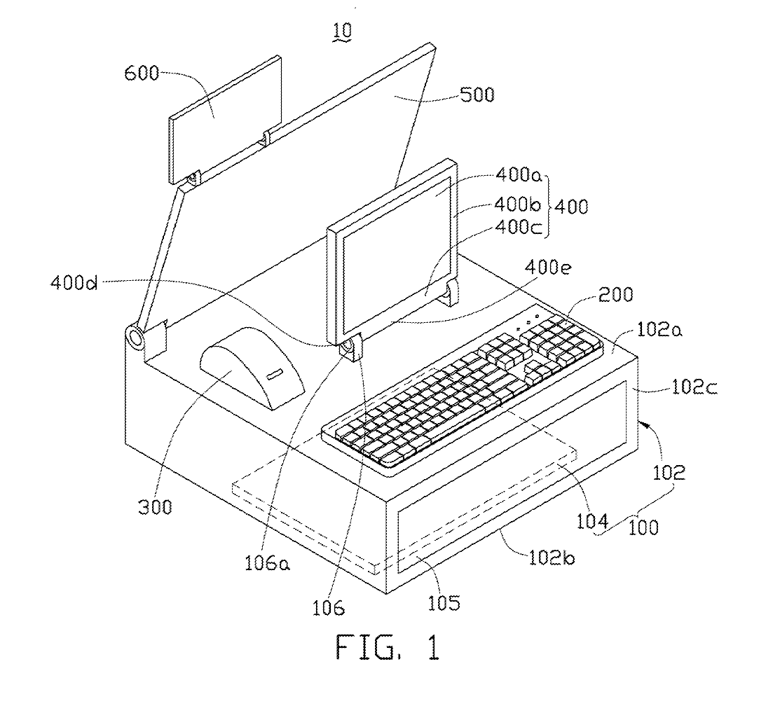

Referring to FIG. 1, a point-of-sale (POS) terminal 10, according to a first embodiment, includes a controller 100, a keyboard 200, a printer 300, a main display 400, a multimedia display 500, and a sub-display 600.

The controller 100 includes a casing 102 and a main board 104 as a controlling unit. The casing 102 includes a top plate 102a, a bottom plate 102b opposite to the top plate 102a, and a front plate 102c perpendicularly connected to the top plate 102a and the bottom plate 102b. An opening 105 is formed in the front plate 102c to allow a drawer (not shown) sliding into or out of the casing 102. The main board 104 is disposed on the bottom plate 102b. Typically, the front plate 102c faces a salesclerk for the sake of convenient operation.

The main display 400 includes a display panel 400a, a frame 400b, and a hinge section 400c. The frame 400b frames the display panel 400a. The hinge section 400c is disposed at the bottom part of the frame 400b, linking the main display 400 to the top plate 102a in such a manner that the main display 400 can be oriented as desired for clear and comfortable viewing for salesclerk. The hinge section 400c includes a rectangular connecting part 400e, two supporting feet 106, and a shaft 400d. The connecting part 400e is disposed at the bottom part of the frame 400b and defines a first hole (not shown) running through the lengthways direction thereof. Each supporting foot 106 defines a second hole 106a both coaxial to the first hole. The distance between the two supporting feet 106 is slightly larger than the length of the connecting part 400e. The shaft 400d passes through the first hole and the second holes 106a. The main display 400 is disposed in the middle of the top plate 102a, facing the salesclerk.

The multimedia display 500 is pivotally mounted on a side of the top plate 102a away from the front plate 102c, facing consumers. A second hinge section (not labeled) is disposed at the bottom part of the multimedia display 500 to link the multimedia display 500 to the top plate 102a in such a manner that the multimedia display 500 can be oriented as desired for clear and comfortable viewing for consumers.

The sub-display 600 is pivotally mounted on a top part of the multimedia display 500, facing the consumers too. A third hinge section (not labeled) is disposed at the bottom part of the sub-display 600 to link the sub-display 600 to the multimedia display 500 in such a manner that the sub-display 600 can be oriented as desired for clear and comfortable viewing for consumers.

The key board 200 and printer 300 can be disposed on a side of the top plate 102a in view of the display panel 400a.

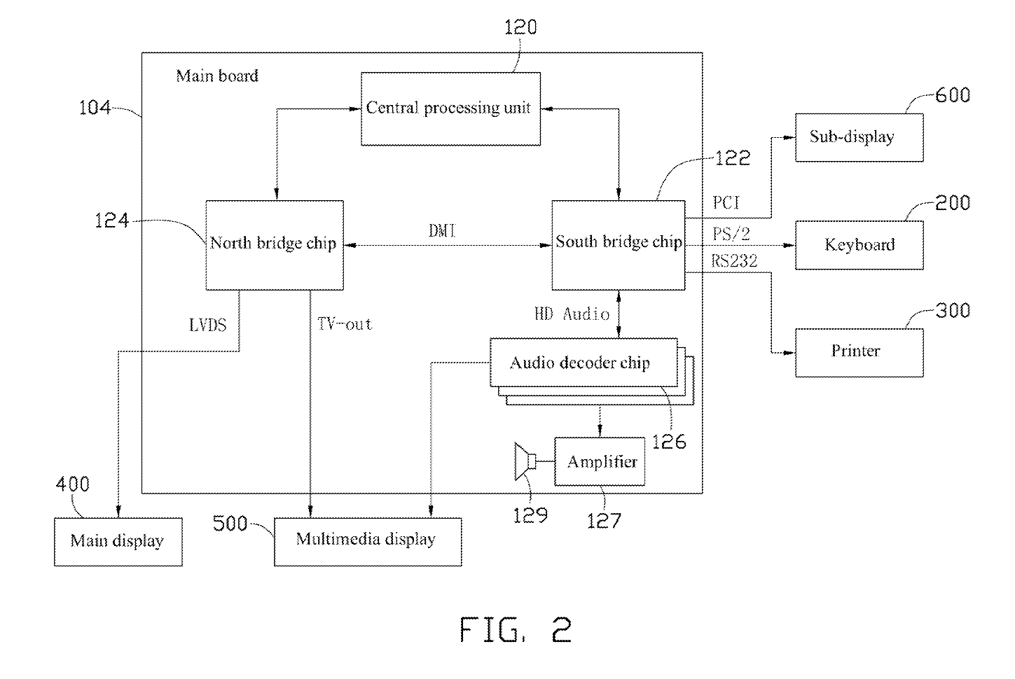

Referring to FIG. 2, the main board 104 includes a central processing unit (CPU) 120, a south bridge chip (SBC) 122, a north bridge chip (NBC) 124 connected to the SBC 122 via a direct media interface (DMI), three audio decoder chips (ADC) 126, an amplifier 127, and a speaker 129. The SBC 122 and the NBC 124 are both connected to the CPU 120.

The SBC 122 is configured for managing communications of input or output (I/O) interfaces, such as peripheral component interconnect (PCI) interfaces, serial digital video out (SDVO) interfaces, high definition (HD) audio interfaces, Personal System 2 (PS/2) interfaces, and RS232 interfaces. The NBC 124 includes a plurality of display drivers connected to the corresponding display output interfaces, such as D-Sub interfaces for cathode ray tube (CRT), low-voltage differential signaling (LVDS) interfaces, TV-out interfaces, and serial digital video out (SDVO) interfaces.

When a bus width of the POS terminal 10 is 32 bit, and an operating frequency of the POS terminal 10 is 33 MHz, a data transfer rate (DTR) of the LVDS interfaces can be up to about 100 Mbps to 2 Gbps, while the DTR of PCI interfaces is only about 133 Mbps. Commonly, the sub-display 600 needs only to display titles and prices of purchased commodities, and the main display 400 can display any additional information and any needed interfaces such as an operating system (OS). In this regard, the main display 400 has relatively higher requirements for DTR. In this embodiment, the main display 400 is connected to the NBC 124 through the LVDS interface, the sub-display 600 is connected to the SBC 122 through the PCI interface. The multimedia display 500 is connected to the NBC 124 through the TV-out interface to receive video information. The three ADCs 126 connect to the SBC 122 through the HD audio interface. In detail, a first ADC 126 is connected to the multimedia display 500 to provide audio information, a second ADC 126 is connected to the speaker 129 through the amplifier 127 to allow the speaker 129 broadcast the sound of salesclerk, a third ADC 126 is connected to a audio interface (not shown) for outer audio equipment to broadcast audio message, such as MP3, stored in the controller 100. The keyboard 200 is connected to the SBC 122 through the PS/2 interface. The printer 300 is connected to the SBC 122 through the RS232 interface.

In operation, the salesclerks may stand in front of the keyboard 200, facing the display panel 400a of the main display 400. The consumers stand in front of the multimedia display 500, facing the display panels of the multimedia display 500 and the sub-display 600. Under the control of the CPU 120 of the controller 100, the OS interface and the titles and prices of purchased commodities are displayed on the main display 400 to salesclerks, the titles and prices of purchased commodities are displayed on the sub-display 600 for consumers, and other messages, such as advertisements or videos, are displayed on the multimedia display 500 for the consumers at the same time.

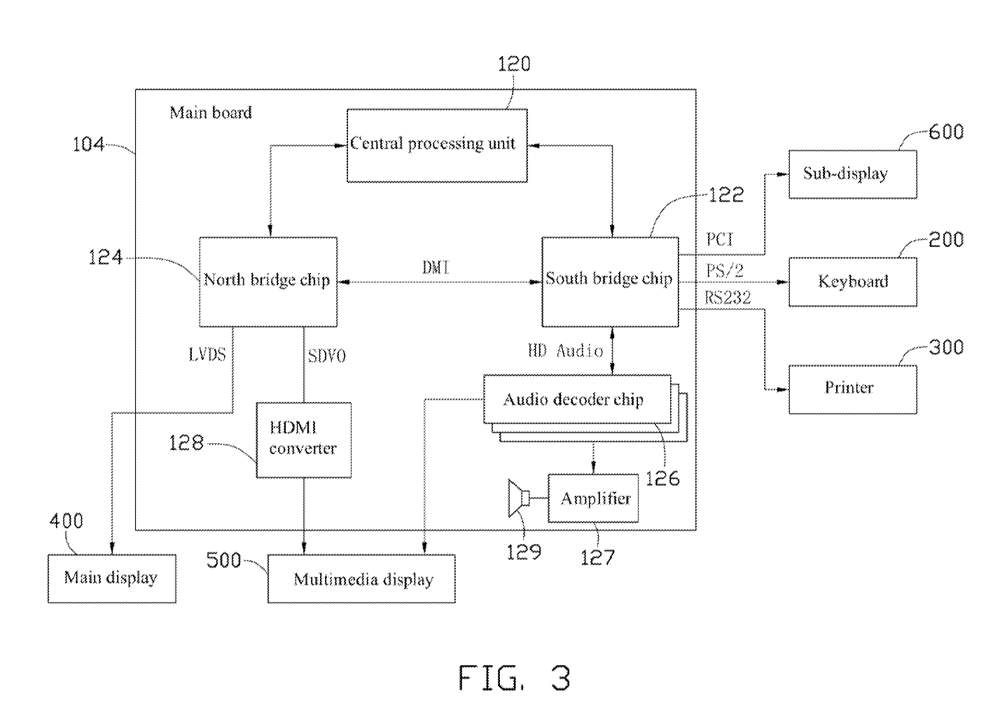

Referring to FIG. 3, in a second embodiment, the main board 104 can also include a high definition multimedia interface (HDMI) converter 128 connected to the NBC 124 through the SDVO interface. The multimedia display 500 is connected to the HDMI converter 128. In this way, high definition video or image can be displayed by the multimedia display 500.

It should be understood that, in alternative embodiments, the multimedia display 500 can be arranged separately in another place. In this situation, the sub-display 600 can also be disposed on the main display 400 or the controller 100 facing consumers.

It should be understood that, in other alternative embodiments, a main display with touch panel (not shown) can be employed to replace the main display 400 and the key board 200.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

1. A point-of-sale (POS) terminal comprising:
a controller including a casing and a main board disposed in the casing, wherein the casing comprises a top plate;
a main display disposed on the top plate, and defining a first display panel;
a sub-display disposed on the top plate, and defining a second display panel facing substantially away from the first display panel of the main display; and
a multimedia display defining a third display panel;
wherein the main board comprises a central processing unit (CPU), a south bridge chip (SBC) connected to the CPU, and a north bridge chip (NBC) connected to the CPU;
wherein the main display is connected to the NBC via a low-voltage differential signaling interface, the sub-display is connected to the SBC via a peripheral component interconnect interface.

2. (canceled)

3. The POS terminal of claim 1, wherein the multimedia display is connected to the NBC via a TV-out interface.

4. The POS terminal of claim 1, wherein the main board comprises a high definition multimedia interface converter connected between main display and the NBC.

5. The POS terminal of claim 1, wherein the POS terminal comprises a keyboard connected to the SBC via a Personal System 2 interface and the keyboard is disposed on a side of the first display panel of the main display.

6. The POS terminal of claim 1, wherein the POS terminal comprises a printer that connected to the SBC via a RS 232 interface and the printer is on a side of the first display panel of the main display.

7. The POS terminal of claim 1, wherein the main display and the multimedia display are pivotally mounted on the top plate with the first display panel and the third display panel facing substantially back away from each other, and the sub-display is pivotally mounted on the top part of multimedia display with the second display panel facing to the same direction with the third display panel of the multimedia display.

8. The POS terminal of claim 7, wherein the main display comprises a hinge section disposed at the bottom part thereof, linking the main display with the top plate in such a manner that the main display can be oriented as desired for clear and comfortable viewing for salesclerk.

9. The POS terminal of claim 7, wherein the multimedia display comprises a second hinge section disposed at the bottom part thereof, linking the multimedia display with the side of the top plate behind the main display in such a manner that the multimedia display can be oriented as desired for clear and comfortable viewing for consumers.

10. The POS terminal of claim 7, wherein the sub-display comprises a third hinge section disposed at the bottom part thereof, linking the sub-display with a top part of the multimedia display in such a manner that the sub-display can be oriented as desired for clear and comfortable viewing for consumers.

11. The POS terminal of claim 8, wherein the hinge section comprises a rectangular connecting part, two supporting feet, and a shaft; the connecting part is disposed at the bottom part of the main display and defines a first hole running through the lengthways direction thereof; each supporting foot defines a second hole both coaxial to the first hole; the distance between the two supporting feet is slightly larger than the length of the connecting part; the shaft passes through the first hole and the second holes.
